(19) United States
(12) Patent Application Publication
(10) Pub. No.: US 2024/0349760 A1
(43) Pub. Date: Oct. 24, 2024

(54) CONTAINERS FOR LIQUID BEVERAGES AND METHODS OF FORMING AND PROCESSING THESE CONTAINERS

(71) Applicants: David Murray MELROSE, Auckland (NZ); Campbell MELROSE-ALLEN, Auckland (NZ)

(72) Inventors: David Murray MELROSE, Auckland (NZ); Campbell MELROSE-ALLEN, Auckland (NZ)

(21) Appl. No.: 18/760,474

(22) Filed: Jul. 1, 2024

Related U.S. Application Data
(63) Continuation of application No. 17/703,688, filed on Mar. 24, 2022, now abandoned.
(60) Provisional application No. 63/165,236, filed on Mar. 24, 2021.

(51) Int. Cl. A23L 3/3481; A23L 2/44; A23L 2/60; A23L 27/30

(52) U.S. Cl. CPC A23L 3/3481; A23L 2/44; A23L 2/60; A23L 27/31

(57) ABSTRACT

In one embodiment, a method of processing and protecting ingredients in a beverage from the effects of photodegradation is provided. The method may include: providing a red coloured container having light transmission properties between about 630 and 700 nm in wavelength; filling the red coloured container with a beverage including water and at least one of the following beverage ingredients to be preserved: High Fructose Corn Syrup (HFCS), Stevia, Aspartame, Sucralose or any other non-nutritive sweetener; capping and/or sealing the red coloured container; wherein the red coloured container is configured to filter an UV/visible light so as to reduce light degradation of the beverage ingredients.

### CROSS-REFERENCE TO RELATED APPLICATION

The present application is a continuation of U.S. Ser. No. 17/703,688, filed on Mar. 24, 2022, which claims the benefit of priority to U.S. Provisional Application Ser. No. 63/165,236, filed on Mar. 24, 2021, which are incorporated herein by reference in their entireties.

### FIELD

The present invention generally relates to both cold and hot-fill plastic containers for protecting and preserving various compounds of both still and carbonated liquid beverages within the container from the effects of photodegradation. In particular, the invention relates to plastic containers having particular properties allowing preservation of the product flavours, nutrients and other qualities for a longer period of time and methods for forming and processing such containers.

### BACKGROUND

### Recycling

Plastic bottle recycling rates vary from place to place around the globe and a variety of factors influences them. When we look at the United States of America, the recycling rate in California is as high as 70%, while in Texas the recycling rate is as low as 5%. Recycling and environmental protection are becoming recognised as essential goals within the beverage industry, governments and broader society.

For this reason, companies engaged in the production and use of plastic containers and packaging are attempting to undertake more sustainable practices. The ideal end goal is creating a “closed loop” with regards to the plastics product life cycle. A closed loop would entail producing plastic products entirely from recycled sources. These products are then recycled into new plastic products, and so on, with as minimal waste in the system as possible.

Factors that affect recycling rates include consumer participation, recycling cost, recycling value and recycling processing efficiencies. The first step in the chain is getting a consumer to identify and deposit a recyclable product correctly. Most of the recyclable bottles in the broader system never make it back to recycling centres because of consumer ignorance, lack of incentive, or error.

However, when a properly educated and motivated consumer correctly deposits a recyclable product the bottle enters an elaborate global system within which its plastic is sold, shipped, melted, resold, and shipped again-sometimes zigzagging the globe before becoming a carpet, clothing, or repeating life as a bottle. This process is possible because plastic is a stubborn substance, which resists decomposition. With a presumed life span of over 500 years, it's safe to say that every plastic bottle you have used exists somewhere on this planet, in some form or another.

The first stop after the collection of the recyclable waste is a type of facility commonly referred to as a recycling plant. However, this first plant only handles part of the recycling process. It primarily sorts, recovers, and discards. The plant sifts through recyclables to recover items that can be resold in the post-consumer (the recycling industry's term for items thrown away by consumers) commodities markets. In this case, the materials sifted include glass, metal, cartons and some plastics. It discards the rest.

Typically, 50% of what you put in your recycling bin is never recycled. It is sorted and thrown out. This is partly due to user error, a common problem which occurs when people place unrecyclable materials into recycling bins.

Single-use plastic bottles, made of polyethylene terephthalate (PET), are loved by recycling facilities because they are easy to resell. Bottles compress easily into 1,000-pound bales of mostly clear, some green plastic. Valued solely for their molecular characteristics, these items are sold as commodities based on monthly national rates.

### PET Colours Recycling Stream

Post-consumer PET or Resin (PCR) is often sorted into different colour fractions: transparent or uncoloured PET, blue and green coloured PET, and the remainder into a mixed colours fraction. The emergence of new colours (such as amber for plastic beer bottles) further complicates the sorting process for the recycling industry.

The sorted post-consumer PET waste is crushed, pressed into bales and offered for sale to recycling companies. Colourless/light blue post-consumer PET attracts higher sales prices than the darker blue and green fractions. The mixed colour fraction is the least valuable.

Sorted PET bales can contain non-PET as well as coloured PET bottles, bottles that contain product residue, labels and closures, and even noncolored PET bottles that are known to present recycling issues. While improved sorting at the MRF level can help with some of these issues, they are not able to readily identify and remove many of these clear problematic PET bottles during their material sorting process.

Therefore, multilayer PET bottles, and those that contain additives that are problematic to recycling (such as oxygen scavengers and ultraviolet light absorbers), can easily slip through and become part of the PET bale. Reclaimers must then try to identify and remove those items.

The reprocessing of these problematic bottles into rPET (or recycled PET) for other uses is poor since this material offers the reclaimers a much lower economic return. Additionally, coloured bottles (other than those dyed light blue and to some extent green) offer reclaimers very low returns. There simply is not enough of any one colour to allow for the development of a unique colour stream.

For U.S. PET beer applications, approximately 10 million pounds of clear, green and amber bottles are created. This is far below the volume needed for the reclaimers to economically produce even a dedicated amber rPET product line. However, if amber PET pharmaceutical and beer packaging usage increases, the reclaimers will eventually face the need to develop an outlet for this material.

While end-use markets exist for high-quality, uncoloured PET bottles, the same cannot be said for coloured alternatives. If the relatively low volume of PET used for amber carbonated soft drink, beer and pharmaceutical PET packaging usage increases, items returned for recycling may reach a level significant enough to warrant their own stream.

Any new colour introduced into the recycling stream creates a problem if not produced in significant enough volume to create inherent value as reclaimable resource. Any new colour which currently is not its own colour stream in recycling systems, needs to be produced in significant numbers and consequently sorted out for recycling and reuse, for the colour to be justifiably considered valuable to sort and resell for recyclers.

### Opaque PET Use

The use of opaque PET in packaging has increased significantly in recent years. This is a plastic that has been made opaque by the addition of certain pigments. Opaque PET can disrupt the recycling process. In the Netherlands, the plastic is not being widely used yet, but in France, this material is already causing problems in the recycling chain. Recyclers must, therefore, systematically remove opaque PET bottles from their input materials. This is, however, at the expense of output and results in an increasing share of PET bottles that will not be recycled. Moreover, there currently is no specific application that requires processing a large amount of opaque PET.

rPET

Producers and manufacturers of PET bottles and other plastic disposable items are under increasing pressure and scrutiny to adopt more ecologically beneficial materials and methods. While many have been using freshly produced plastics for their containers, more and more they are beginning to utilise recycled plastics (rPET) into their production.

When companies choose to use rPET in their products, they provide a market for recycled plastics. Like any business, recycling facilities have to make money-if they are not turning a profit from the materials they collect, they will stop collecting them. When consumers purchase products made with recycled content, they are sending a message to companies that they value their sustainability efforts. By creating awareness and demand for recycled products, we help solidify recycling programs and recycled goods as valuable pieces in the production process.

Making a new bottle, however, is slightly more complicated. The plastic flakes must be sterilized and tested to meet food-grade standards. This means plastic flakes are melted, extruded as ribbons of liquid plastic, and shaped into smooth rice-grain-sized pieces. These tiny pellets will be sold to a manufacturer as raw materials for takeaway food containers and, of course, plastic bottles.

Melt filtration is typically used to remove contaminants from polymer melts during the extrusion process. There is a mechanical separation of the contaminants within a machine called a ‘screen changer’. A typical system will consist of a steel housing with the filtration medium contained in moveable pistons or slide plates that enable the processor to remove the screens from the extruder flow without stopping production. The contaminants are usually collected on woven wire screens which are supported on a stainless-steel plate called a ‘breaker plate’—a strong circular piece of steel drilled with large holes to allow the flow of the polymer melt. For the recycling of polyester, it is typical to integrate a screen changer into the extrusion line. This can be in a pelletizing, sheet extrusion or strapping tape extrusion line.

rPET-Yellowing

One of the problems that limits the amount of recycled PET (rPET) or PCR used in rigid packaging applications is the degree of yellowness that it can cause. The more rPET or PCR that is added to virgin PET during bottle manufacture, the more yellow the resulting bottle tends to become.

There are many other causes that also contribute to this problem. For example, it is known that low levels of nylon coming from multilayer bottles can remain trapped in the PET flake after washing and cleaning. This residual nylon will cause considerable yellowing when the rPET is extruded. The presence of additives such as ultraviolet (UV) light blockers, acetaldehyde and oxygen scavengers, and slip agents can all contribute to yellowing as the rPET is subjected to additional melt histories.

However, one cause of yellowing that has not been widely addressed is the effect that UV radiation from the sun, as well as that emitted by artificial sources, such as fluorescent lighting, can have on PET. PET is sensitive to UV light especially at elevated temperatures, under high humidity, and in the presence of oxygen-all of which are present when PET bottles are exposed to the weather.

Surprisingly, even if there is not a significant amount of yellowing seen in the colour of bottle flake used in the production of a bottle, yellowing can still become significant after weather-exposed PET has been subjected to melting required for moulding the plaques, creating additional problems to be considered when using rPET in the production of bottles.

Because of the yellowing phenomenon, buying recycled PET can be more expensive than purchasing virgin material. High-grade, clear rPET is coveted for its purity and clarity while the lower grade is shunned due to its propensity to yellow the fresh containers produced from it. This poses an obvious problem for the industry that wants to increase its rPET usage but is as always cost averse. A secondary problem arises as few producers are willing to accept the lower grade and “dirtier” rPET in their products for justifiable fear of negative consumer perception.

While reclaimers struggle to produce a high quality non-coloured clear rPET product, they face many challenges. One of the most difficult problems for them to address is the natural tendency of even virgin PET to yellow as it is repeatedly subjected to additional melt histories during production of rPET pellets. This yellowing is accentuated by the presence of some additives such as ultraviolet light absorbers and oxygen scavengers, as well as residual multilayer barrier materials that cannot be removed in the recycling process. Reclaimers can add toners to mask this yellowing to some extent, but this adds cost and can make the resulting rPET material less bright when the toner level becomes too high.

Additionally, reclaimers know that they must do a very good job during their resorting process to eliminate as many known problem PET bottles as possible from these curb side bales. Typically, they will remove PET bottles that contain multilayer structures as well as others that contain additives that could present yellowing problems to their recycling process.

One of the problems that limits the amount of recycled PET (rPET) used in rigid packaging applications is the degree of yellowness that it can cause. The more rPET that is added to virgin PET during bottle manufacture, the more yellow the resulting bottle tends to become.

The source of the rPET used has a great influence on yellowing. Deposit-grade materials are in the greatest demand as they result in less yellowing than do curb side grade material. Even virgin PET will discolour and yellow with each additional melting cycle.

But there are many other causes that contribute to this problem. The presence of additives such as ultraviolet (UV) light blockers, acetaldehyde and oxygen scavengers, and slip agents can all contribute to yellowing as the rPET is subjected to additional melt histories. A study performed by Phoenix Technologies, LLC looked at the effects that adhesives used to adhere labels to bottles had on yellowing. The results showed that these could be a significant contributor when not washed away from the PET flake during the cleaning process.

Free radicals form within the plastic that cause subsequent degradation. The degradation effects seen are also compounded by the presence of oxygen in the air. The free radicals created by the UV radiation react with this oxygen to form hydroperoxides that can result in polymer chain breakage. Thus, the end result in many plastics, including PET exposed to an outdoor sunny environment, is that they will discolour, embrittle, and crack over time. While antioxidant and UV absorbers can be added to the plastic to help stabilize and prolong the material's useful life, PET bottles normally do not contain significant amounts of these additives. The Association of Postconsumer Plastic Recyclers (APR) notes in their model bale specification for PET bottles, that bales should not be stored outdoors uncovered for a period exceeding two weeks to prevent UV degradation. There have been many papers published that describe the degradation effects that UV light has on PET3-5. But these papers have primarily focused on the degradation seen on the actual PET article being studied and not what happens to the properties of PET when it is recycled.

The very nature of the colour yellow limits its incorporation into certain container colours. Yellowing PET used for the production of blue containers will result in a green tinted end product. Clear PET production is obviously the worst effected as the yellowed bottles are exceptionally off putting to consumers. Currently amber may be used to mask the yellowed PET, but amber comes with its own negative consumer perceptions and associations with certain beverages only. The colour red would also offer superior masking of rPET yellowing.

The ability for a container colour to mask the yellowing of rPET is extremely commercially significant. By successfully obscuring this yellowing, producers of plastic and PET containers are able to purchase and reuse lower grade PET in their products. This results in a multitude of benefits. Yellowed PET that would otherwise not get recycled is able to be recycled instead of discarded and lost to the recycling loop. Cheaper material can be purchased, lowering the cost of producing an rPET container. And significantly more rPET can be implemented within a recycled container. While producers of rPET containers within the industry currently are reluctant to use more than 25% rPET or PCR in their containers for fear of consumer backlash, a more successfully masked rPET container could use upwards of 75% to 100% recycled material.

### Wavelengths of Light

Light is electromagnetic radiation within a certain portion of the electromagnetic spectrum. The word usually refers to visible light, which is the visible spectrum that is visible to the human eye and is responsible for the sense of sight. Visible light is usually defined as having wavelengths in the range of 400-700 nanometres (nm), or 4.00×10−7 to 7.00×10−7 m, between the infrared (with longer wavelengths) and the ultraviolet (with shorter wavelengths). This wavelength means a frequency range of roughly 430-750 terahertz (THz). Generally, electromagnetic radiation, or EMR, is classified by wavelength into radio waves, microwaves, infrared, the visible spectrum that we perceive as light, ultraviolet, X-rays, and gamma rays.

The behaviour of EMR depends on its wavelength. Higher frequencies have shorter wavelengths, and lower frequencies have longer wavelengths. When EMR interacts with single atoms and molecules, its behaviour depends on the amount of energy per quantum it carries.

Electromagnetic wavelengths of UV light are shorter than the wavelengths of visible light. Within the visible spectrum UV light is closest to blue visible light, and at the opposite end of the visible spectrum, we find red light with longer wavelengths. Beyond red, electromagnetic wavelengths lengthen further to become infrared waves.

Ultra Violet wavelengths are grouped into a few categories. UV-A wavelengths are between 315 and 400 nm. UV-B wavelengths are between 280 and 315 nm.

The shortest wavelength found in the visible spectrum is then Violet light which is present above 400 nm. After this comes Indigo at 425 nm. Then Blue at 470 nm, Green at 550 nm, Yellow are 600 nm, Orange at 630 nm and finally Red at 665 nm.

Red light propagates as photons of the lowest energy in the visible spectrum. Which is why sensitive environments that contain items or compounds that are reactive to light, like a photography darkroom, will feature a low energy red lamp for visibility.

Light and the Interaction with Beverage Bottles

The different materials and colours of beverage bottles transmit light in varying ways. These differences have a considerable consequence for the beverage sealed within. Various beverages also have considerably different reactions to light exposure, depending on their chemical composition and individual sensitivities. Clear containers allow transmission of most electromagnetic radiation, or light, into the beverage inside. While coloured containers absorb parts of the electromagnetic spectrum and only allow transmission of certain frequencies through. Furthermore, glass and plastic exhibit differing transmission rates themselves, with glass absorbing much of the UV spectrum while plastic does not.

The protection offered by clear glass falls off steeply towards the upper region of the UV spectrum, giving poor protection at some critical wavelengths. Clear glass allows around 90% of light with a wavelength of 350 nm to pass. Green glass gives better protection than clear but at 370 nm it still allows about 70% of light to pass. By contrast, amber glass gives excellent protection over the full UV spectrum and even well into the visible region.

The protection afforded by clear glass is seen to diminish rapidly at wavelengths longer than 300 nm. Green glass, the traditional choice of a winemaker, is seen to provide intermediate protection between clear and amber glasses. Meaning that amber glass exhibits excellent filtering properties of from shorter electromagnetic wavelengths. This means that while green filters some, amber filters out most of light that is potentially damaging to beverages and food products.

Amber is often used within the industry for light sensitive products, due to its excellent filtering of the UV spectrum. Amber is technically a very dark yellow or orange, colours which primarily transmit light wavelengths around 600 to 630 nm. However, amber has its downsides as a bottle colour, it is particularly dark and drastically obscures the contents contained within. Over the years amber has become heavily associated with beer due to its almost universal application within the sector, which is the case because beer is extremely light sensitive and therefore requires high UV protection. For this reason, amber has garnered a negative consumer perception when it is employed with other beverage products. An example, even though amber bottles offer superior UV protection to green bottles, the wine industry has been reluctant to bottle in the former because of the fear of being associated with the beers cheaper price point and perceived status. A similar effect is present in the soft drinks industry that shies away from dark amber colours seeing the bottles as dull and undesirable for their target consumers. Colours that are dark tend to get lost on supermarket shelves brimming with colour.

One colour which has had little attention from the beverage industry is the colour red. As stated above red light is designated at the wavelengths around 665 nm. This wavelength is even farther away from the UV-A and UV-B spectrums than amber, the current industry standard for light filtration. As such a red coloured container is capable of more effectively protecting its contents from these harmful rays while not needing to be tinted quite so darkly. The positive results of this would be an original container, free from consumer connotations other than being relatively unique and different, that does not need to obscure the beverage within as badly as an amber container.

The absorption of light by a substance increases its redox potential, which makes species in that substance more reactive. In wine, for example, UV radiation catalyses the reaction of sulphur containing amino acids to form volatile compounds that are exceptionally stinky; onion and cooked cabbage aromas (dimethyl sulphide (DMS) for example). UV radiation in particular and, to a lesser extent, visible light promotes (catalyses) these unwanted reactions.

The fluorescent lighting used in many stores emits the shorter wavelengths that include those known to produce unwanted chemical reactions.

### Photochemical Reactions

Chemical reactions that result from irradiation of chemical compounds with light have traditionally been called photochemical reactions, and their study comprises that science called photochemistry. With the advent, during the last two decades, of many techniques that allow direct measurements on reactive intermediates, and on molecules in electronically excited states, the term photochemical reaction has taken on a more specific definition: a photochemical reaction starts in one of the electronically excited states of a reactant and ends with the appearance of the first ground-state product(s). That is, photochemical reactions comprise that class of electronic relaxation processes that do not lead back to the starting molecule. With this definition comes the insight provided by the notion that photochemical reactions differ from conventional thermal reactions in that photochemical reactions always involve a molecule possessing an excited electron.

### UV Damage on Beverages

Light is widely known to promote food degradation phenomena such as the oxidation of lipids, vitamins, and natural pigments, which results in the formation of unpleasant off-flavours, loss of nutritional value, and colour fading. Lipids, vitamins or Sulphur-containing amino acids make wine vulnerable to UV light, for example, resulting in significant damage to the consumer product and experience if handled or stored incorrectly.

Beer for example can be degraded by light to form skunked or light-struck beer. Skunked beer is the result of the interaction between light and hops. During the brewing process, hops are broken down into bitter iso-alpha acids (isohumulone). These compounds when exposed to light, break down into free radicals that then interact with Sulphur-containing proteins. This reaction promotes the formation of 3-methyl-2-butene-1-thiol which has a stinky, cabbage-like aroma. The detection threshold for these compounds is exceptionally low, around 1 part per billion can be detected. As such, beer is either contained in brown bottles or cans in order to minimise light exposure.

### UV on Artificial and Natural Sweeteners

There is a growing demand for low calorie, high-potency sweeteners as a substitute for sucrose and high fructose corn syrups in food and beverages, and considerable effort has been invested in identifying natural products that provide sweetness and flavour without compromising taste. The use of non-caloric high intensity sweeteners is also increasing due to health concerns raised over childhood obesity, type II diabetes, and related illnesses. Thus, a demand exists for sweeteners having a sweetness significantly higher than that in conventional sweeteners, such as granulated sugar (sucrose).

However, diet sodas and other beverages that contain artificial or natural sweeteners are potentially more unstable than sodas and beverages containing more typical sugars. Artificial sweeteners in diet sodas and beverages begin to chemically break down over time and the diet soda or beverage will actually taste worse and lose its sweetness the further away you get from the consume by date.

### Stevia (Natural Sweetener)

Stevia is a sweetener and sugar substitute extracted from the leaves of the plant species Stevia rebaudiana, native to Brazil and Paraguay. The active compounds are steviol glycosides (mainly stevioside and rebaudioside A), which have 30 to 150 times the sweetness of sugar, are heat-stable, pH-stable, and not fermentable. The body does not metabolize the glycosides in stevia and therefore it contains 0 calories like some artificial sweeteners.

There is even contention as to whether UV exposure breaks stevia down into potentially toxic compounds including steviol aglycone. While the toxicity of steviol aglycone has been debated by the industry it has yet to be proven dangerous for human consumption. Whether or not UV light breaks stevia down into steviol aglycone in low pH beverages, stevia sweetness properties are significantly degraded by heat exposure.

A study from the Rheinishe Friedrich-Wilhelms-Universitat Bonn, tested the stability of rebaudioside A and stevioside in soft drinks after 24, 48 and 72 hours of storage at 80 degrees Celsius. The results indicated that there was significant degradation of stevioside and rebaudioside A under these extreme conditions, where up to 70% degraded.

Stevia has however been shown to remain stable and acceptably sweet in lemon-lime and cola drinks for over 26 weeks in accelerated shelf life studies, while the majority of soft drinks of this type are consumed with 16 weeks of bottling.

Coca-Cola reported in 2009 that high purity stevia extract (rebaudioside A) does not degrade in beverages on exposure to light. This research was important in establishing the stability of the stevia-derived sweetener.

### Aspartame (Artificial Sweetener)

Aspartame is an artificial sweetener used as a sugar substitute in some foods and beverages. It is most commonly found in beverages such as Diet Coke. Aspartame is a dipeptide and is approximately 200 times sweeter than sucrose (table sugar) and has a low caloric value (17 KJ/g). Amino acids and peptides (which are short chain amino acids) are particularly sensitive to light. For example, in wine, light induces the breakdown of amino acids such as methionine and cysteine to release volatile and smelly compounds such as dimethylsulphide and hydrogen sulphide.

In a study conducted by Celine Couteau at the University of Nantes in 2000, it was found that aspartame degraded as a result of UV exposure. In the experiment, solutions of aspartame were exposed to a UV light source. The absorbance spectra of aspartame was then analysed between 200 nm and 400 nm with a spectrophotometric method. A liquid chromatographic method was used for the determination of aspartame concentrations, initially and at various times. The analysis was carried out in triplicate samples. The results of the experiment show that aspartame expressed maximum absorption at 257 nm. The shelf life of aspartame was defined as the time by which the aspartame concentration had decreased by 10% from the initial concentration, which was calculated as 43.6 minutes. As such, this study confirms that aspartame is susceptible to photodegradation.

Furthermore, in a study titled Photocomposition of aspartame in aqueous solutions completed by S. K. Kim et al. (1997), it was found that the higher the light intensity, the greater the degradation of aspartame. The photodecomposition rate of aspartame also varied with the pH of the system. Aspartame degradation was fastest at pH 7.0, followed by pH 4.0 and pH 6.0, in decreasing order. Coke Zero, being an acidic beverage, has a pH of 3.18.

### Monatin (Natural Sweetener)

Monatin, also known by the common name arruva, is a naturally occurring high-potency sweetener isolated from the Sclerochiton ilicifolius plant found in regions of the Transvaal, South Africa. This compound is related to the amino acid tryptophan (Trp), and has a sweet taste without contributing significant calories to formulations in which it is included. (2R,4R)-Monatin has been reported to be over 3000 times sweeter than sucrose at 5% sucrose equivalence making it one of the most potently sweet natural substances known. Monatin is known to be photosensitive and to degrade to malodorous degradation products when exposed to UV light. A particular photodegradation product of monatin is skatole or 3-methylindole, which has an unpleasant odor.

Stability studies have shown that exposure of mock beverage solutions containing monatin to long-term UV/visible photolysis results in a loss of sweetness and the formation of unpleasant flavours and aromas. Prevention of such degradation is therefore a key consideration in the use of this compound. Monatin loss is known to occur via multiple pathways involving both non-oxidative and oxidative pathways.

A recent study investigated the protective effects of light filters on monatin photooxidation. Solutions of monatin contained in optically transparent (cut-off<330 nm), green and yellow plastic PET bottles were illuminated for 14 days and analysed. Both the green and yellow plastic afforded protection against monatin loss throughout the 14 day illumination period compared to the controls, with monatin loss being about 26%, 22%, and 20% for clear, green and yellow PET filters respectively. The yellow plastic gave significantly greater protection than the green filter from day 3 onwards. Several blue-coloured filters were also investigated, but these did not afford protection against monatin degradation when compared to the <330 nm cut-off plastic controls. This data indicates that plastics that absorb in the visible region of the spectrum provide better protection than those that only absorb UV wavelengths.

Thus, plastic with an absorption cut-off at about 390 nm afforded better protection than that with cut-off at about 330 nm, and the green and yellow plastics were even more effective. These findings support the use of optically opaque or coloured (yellow/brown/green) packaging as an approach to limit monatin degradation.

Correspondingly, the U.S. Pat. No. US2012/0282377A1 (U.S. patent application Ser. No. 13/465,919), incorporated herein in its entirety, presented an invention to provide improved methods of inhibiting the photodegradation of photosensitive sweeteners such as monatin by packaging the food or beverage formulation in a UV absorbing container and/or adding a photodegradation inhibiting amount of one or more antioxidants to the food or beverage formulation.

### UV on Fructose (Sugar)

Ultraviolet light (UV) processing of juices has emerged as an attractive alternative to heat pasteurization due to its effectiveness in inactivating bacteria and enhanced retention of flavour and nutritional attributes. It also has effects on nutritional compounds within solution. Fructose has shown a significant reactivity during ultraviolet light (UV, 254 nm) processing of fruit juices that can adversely affect product quality.

Recent studies demonstrate that the reactivity of fructose is due to the oxidative nature of products formed from UV induced photolysis of fructose. This was accomplished using fluorescein, a fluorescent dye that loses fluorescence intensity upon reaction with oxidative species. Fructose caused a concentration-dependent decay of fluorescence from fluorescein only in presence of UV, indicating oxidative nature of photolysis products of fructose. The transient oxidative species including free radicals and not one of the final photolysis products, furan, were responsible for fluorescence decay. Addition of an antioxidant and removal of oxygen from solution lowered the rate of fluorescence decay, suggesting strategies that can be employed to lower the deleterious effects of fructose on the product.

Furthermore, these radicals appear to transverse layers of a model system of a solid food surface, approximated by 1% agarose gels. In addition, riboflavin or vitamin B2 undergoes photolysis under UV exposure, and caused a concentration-dependent decay of fluorescence from fluorescein only in the presence of UV, indicating oxidative nature of the photolysis products. The understanding developed can be used to optimize UV processing of juices and potentially solid food systems.

These studies provide direct evidence that UV exposure of fructose leads to the formation of reactive oxidative species. Experimental evidence suggests these species are likely to be responsible for the previously observed rate accelerating effects of fructose on UV induced degradation of ascorbic acid and patulin.

### UV on HFCS (Modified Sugar)

The results of these studies clearly highlight the oxidative nature of UV exposed fructose. The observations made in this study are significant since the majority of fruit and juices contain fructose. Therefore, studies are necessary to further evaluate its effect on other vitamins, phytochemicals and flavour compounds. The oxidative effect of fructose may be more pronounced in juice products that are sweetened by high fructose corn syrup.

### UV on Vitamins and Minerals

Many vitamins are sensitive to the effect of UV light and, therefore, sunlight. The vitamins highly sensitive to light are A, D, K and B2. Vitamins E, C, B1, B6, B12 and folic acid also exhibit sensitivity to light. Because of their multiple oxidation states, the presence of metal ions (iron and copper) accelerates degradation of vitamins, especially vitamins C, A, and B1. Fortification with several vitamins can give rise to vitamin-vitamin interactions that can accelerate the rate of breakdown of some vitamins; the best-known interactions are those among vitamins C, B1, B2, B12, and folic acid.

The degradation rates of some common vitamins contained in beverages:
Vitamin C or ascorbic acid is more susceptible to degradation when exposed to wavelengths of less than 400 nm, with maximum degradation occurring at 330-350 nm;
Vitamin E is degraded by oxygen in a reaction catalysed by light. The intensity and wavelength of light as well as the amount of oxygen available influences the rate of degradation. Vitamin E is particularly sensitive to wavelengths between 285 and 305 nm;
Vitamin K has been reported to decrease in concentration by 50% following 3 hours of strong sunlight;
B2 or riboflavin can be degraded significantly (in excess of 10%) when exposed to cool and warm artificial light over a period of 24 hours. One of riboflavin's more undesirable properties is that it can act as a photochemical sensitizer. When riboflavin is in an excited state it can react directly with substrates or aid in the production of reactive oxygen species. Production of such reactive species may in turn, cause the oxidation of other constituents in a beverage; and,
B6 or pyridoxine has been reported to be reduced by 86% in 8 hours after exposure to direct sunlight.

### On Colour and Phenolic Compounds

Phenolic compounds are aromatic structures that are particularly important for beverages such as wine. Phenolic compounds provide sensory attributes such as mouthfeel to a wine, along with contributing to its colour. Most phenolic compounds exhibit some light absorbance at 280 nm, such as flavonoids (e.g. catechins and tannins), flavonols (e.g. quercetin) and non-flavonoids (e.g. hydroxycinnamic acids). The most important phenolic compound in terms of light sensitivity is anthocyanin, which contributes to a wine's colour. Anthocyanin absorbs in the visible part of the spectrum (520 nm), and as such is coloured-red. If anthocyanin is not bound to another phenolic compound, it is vulnerable to bleaching. As such, red wine can lose its colour due to the interaction between light and unbound (monomeric) anthocyanin.

### Additional Container Colouring Information

Colourful PET packaging has been around for quite some time now. Colour often plays an important role in drawing the attention of consumers to a particular product. But colour can have a practical function as well. Certain colours are used to protect light-sensitive vitamins and flavours from degradation as a result of exposure to ultraviolet (UV) light. For light-sensitive products, such as UHT white milk, a light barrier needs to be added to conventional PET bottles, for example by mixing a pigment—mainly titanium dioxide (TiO2)—into the PET, or by putting a wrapper or a sleeve around the bottle. Titanium dioxide is a mineral whitener with very good coverage that is added to the production process of PET packaging in a variety of concentrates, either alone or in combination with other additives (such as certain colour pigments, carbon black, mica, silica, . . . ).

Traditionally plastic containers have been formed from either clear or coloured plastics. Once these containers are used and deposited into the recycling system they are relegated to a particular “stream”. Clear, green, blue and other colours are all separated from each other. This is because the pigment is imbued into the plastic and traditionally impossible to remove. This is why separation of the plastics streams is essential, as green plastic cannot be recycled into clear plastic containers for example.

Coating trials with removable ink have been successful. PET sheet material was printed with differing levels of ink coverage and then thermoformed. The ink used was approved for indirect contact with food, that is, the ink was applied to the outside of the tray. During thermoforming, the ink demonstrated good adhesion and resistance to scuffing. Washing trials were carried out under varying conditions. The ink was easily removed when the flakes were subjected to shearing forces however when the flakes exhibited a curl, the softened ink was protected to an extent and then less readily removed. Consequently, completely clean flakes were not produced from these samples. However, since a significant amount of the ink was removed it would be possible, with some further development work, to optimise the ink system to give good scuff resistance and be fully removable in conventional recycling washing processes.

The washed PET flake samples were also treated to a laboratory scale recycling process used to render PET recyclate safe for use as food contact material. The resultant flake was then evaluated by gas chromatography/mass spectroscopy (GC-MS) and compared to a batch of standard food-grade recycled PET.

The results showed that there was no difference in the volatile behaviour of the two materials indicating that both samples would comply with the food grade regulations. As with all new food contact packaging, overall migration testing would need to be completed before the packaging could be used.

### SUMMARY

It is an object of the invention to provide a system and/or method and/or apparatus that at least goes some way to addressing at least one of these needs, or other needs as will become apparent herein.

In one aspect, a method of processing and protecting ingredients in a beverage from the effects of photodegradation is provided. The method may include: providing a red coloured container having a substantial amount of PCR, with light transmission properties between about 630 and 700 nm in wavelength; filling the red coloured container with a beverage including still or carbonated water and at least one of the following beverage ingredients to be preserved: Vitamin A, Vitamin D, Vitamin K and Vitamin B2, Vitamin E, Vitamin C, Vitamin B1, Vitamin B6, Vitamin B12, High Fructose Corn Syrup (HFCS), Stevia, Aspartame, Sucralose or any other non-nutritive sweetener; capping and/or sealing the red coloured container; wherein, the red coloured container is configured to filter an UV/visible light so as to reduce light degradation of the beverage ingredients.

In one embodiment, the method may further include labelling the red coloured container.

In another embodiment, the beverage may further be filled hot into the container. Examples of hot-filled containers that are particularly useful within the present invention are described in U.S. patent application Ser. No. 16/901,925, the entire contents of which are incorporated herein.

In a further embodiment, the beverage may further include monatin or an UV stabilizer.

In one embodiment, the red coloured container may be manufactured from a plastic material including an UV filter.

In another embodiment, the red coloured container may be manufactured from or may include a quantity of recycled PET equals to or greater than about 25%, greater than about 50%, greater than about 75%, or from a 100% recycled PET.

In a further embodiment, the red coloured container may be manufactured from greater than about 5% ‘secondary value’ recycled PET or from greater than about 50% ‘secondary value’ recycled PET.

In one embodiment, the providing may include forming the red colored container.

In another embodiment, the forming may include blow molding the red container using a red colored PET or recycled PET.

In a further embodiment, the forming may include forming: blow molding a clear or near clear PET to form a substantially clear container; and, coating the formed clear contained with a red colorant or ink to form the red colored container.

In a second aspect, there is also provided a container including: an external wall defining an interior volume; and, the internal volume adapted to receive and hold a volume of beverage, the beverage including still or carbonated water and at least one of the following ingredients: High Fructose Corn Syrup (HFCS), Stevia, Aspartame, Sucralose or any other non-nutritive sweetener; wherein, the external wall is formed from a substantially red color having light transmission properties between about 630 and 700 nm in wavelength and is configured to filter an UV/visible light so as to reduce light degradation of the ingredients present in the beverage.

To those skilled in the art to which the invention relates, many changes in construction and widely differing embodiments and applications of the invention will suggest themselves without departing from the spirit or scope of the invention as defined in the appended claims. The disclosures and the descriptions herein are purely illustrative and are not intended to be in any sense limiting.

### BRIEF DESCRIPTION OF THE DRAWINGS

One preferred form of the present invention will now be described with reference to the accompanying drawings in which:

FIG. 1 shows the electromagnetic spectrum; and,

FIG. 2 is a block diagram illustrating a method of processing a carbonated beverage, constructed and operative in accordance with embodiments of the present invention.

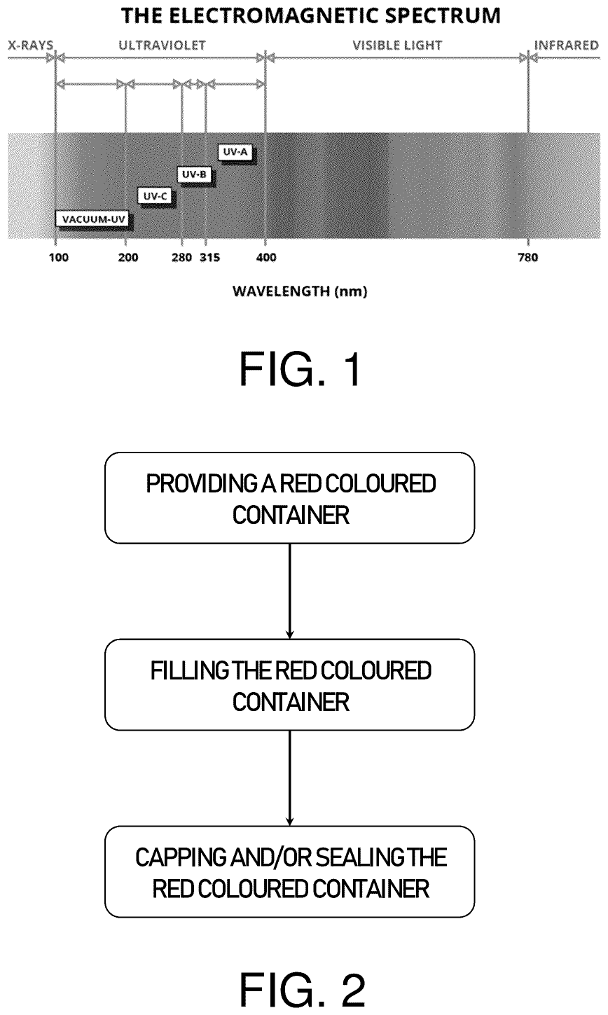

### DETAILED DESCRIPTION

In the following description, numerous specific details are set forth in order to provide a thorough understanding of the various principles of the present invention. However, those skilled in the art will appreciate that not all these details are necessarily always required for practicing the present invention.

The inventive method, which is described hereinafter, allows packaging, protecting and preserving of various compounds present in both still and carbonated beverages from the effects of photodegradation. It is particularly advantageous that the method preserves the product flavours, nutrients and other qualities that contribute to the product experience for a longer period of time than is typical in the industry.

Reference is now made to FIG. 2 which illustrates an exemplary method of processing a beverage to be preserved. At step 210, the method may comprise providing a container configured to receive a beverage that may be carbonated or non-carbonated, and either cold or hot-filled. For example, the bottle may be blow moulded to form a container that is primarily red in colour, and may comprise at least 25% PCR composition. In one embodiment, a red coloured PET can be used and blow moulded to form the container. In another embodiment, a clear, or otherwise near clear PET may be blow moulded and then, coated with a red colourant or ink. At the end of step 210, a PET container having a substantially red colour primarily transmitting light between about 630 and 700 nm in wavelengths is therefore formed.

The formed primarily red PET container may then be filled at step 220 with a beverage comprising of still, or carbonated or soda water and at least one of the following ingredients: Sucrose, Fructose, High Fructose Corn Syrup (HFCS), Sucralose, Stevia, Aspartame, Vitamin A, Vitamin D, Vitamin K and Vitamin B2, Vitamin E, Vitamin C, Vitamin B1, Vitamin B6, Vitamin B12, flavourings, acids or preservatives. The primarily red container formed at step 210 and filled at step 220 allows the ingredients to be protected within by means of filtering the more harmful end of the electromagnetic spectrum and also prevents the damaging light rays within the ultraviolet spectrum from reaching the beverage. By forming and providing a container having a primarily red colour, protection and preservation of the contents of the container can be achieved in a superior way to containers currently present in the industry as red is the farthest distance in the electromagnetic spectrum from the ultraviolet wavelengths and therefore offers a superior protection compared to other coloured containers.

At step 230, the primarily red container may then be capped or otherwise sealed, whereby the red colour present in the PET container filters out a significant amount of the UV light wavelengths that pass through it. This in turn protects the stability of the ingredients of the beverage within from the damaging effects of these Ultraviolet rays.

The formed primarily red PET container may be formed or comprise a significant amount of recycled PET. For example, the container may comprise a particular amount of recycled PET (rPET). The amount of rPET may be equal to or above 25%, but may be anywhere between 50% and 100%, and more preferably between 75% and 100%.

Another advantage of primarily red PET container is that the red colour can act as a mask for the yellowing effect that is often prone to occur in the rPET after multiple melts and blow-mould extrusions. As the red segment of the colour spectrum is adjacent to the yellow segment, the two colours can mix with little or no noticeable effect on the final colour or aesthetic quality of the formed container.

The present invention allows for the use of much lower grade recycled PET to be incorporated back into the freshly produced containers. The lower grade PET that is often removed from the recycling stream(s), those which contain oxygen scavenging or ultraviolet light protecting barrier technologies, or otherwise have multiple recycling melt histories resulting in more visible yellowing. This material can with the application of the invention be used without negative repercussion to the aesthetic quality or consumer perception of the final product. This offers a huge benefit insofar as cheaper and plentiful low-grade PET can be purchased from recycling centres for use as raw material, offering greatly enhanced commercial and ecological potential.

The formed primarily red PET container can also be easily and more clearly identified as its own stream within the recycling systems and therefore the reclamation rate of consistent quality PET can be greatly enhanced. With very few other red containers in the recycling system, the purity of the PET reclaimed will be of a much higher standard than other colour streams present in the system that consist of many differing products, producers and plastic compositions.

In the embodiments where the container is formed from clear, or otherwise near clear PET and then coloured or tinted red with ink or other colouring method, the PET can be cleaned of its red colour during the standard washing, flaking and processing phases during the recycling process. This can then produce high grade clear PET that has been significantly protected from Ultraviolet damage, and can in turn be less yellow than much of the other PET in the system, rendering a higher value recyclable PET.

Another embodiment of the present invention relates to a method of mass producing a plastic container of an uncommon colour not presently active in the recycling stream, and then reclaiming said new coloured container, thereby ensuring the consistency and purity of all the reclaimed plastic.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features.

Furthermore, where reference has been made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

Although this invention has been described by way of example and with reference to possible embodiments thereof, it is to be understood that modifications or improvements may be made thereto without departing from the spirit or scope of the appended claims. It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

1. A method of processing and protecting ingredients in a beverage from the effects of photodegradation, the method comprising:
providing a red coloured container having light transmission properties between about 630 and 700 nm in wavelength;
filling the red coloured container with a beverage comprising still or carbonated water and at least one of the following beverage ingredients to be preserved: High Fructose Corn Syrup (HFCS), Stevia, Aspartame, Sucralose or any other non-nutritive sweetener;
capping and/or sealing the red coloured container;
wherein the red coloured container is configured to filter an UV/visible light so as to reduce light degradation of the beverage ingredients.

2. The method of claim 1, further comprising labelling the red coloured container.

3. The method of claim 1, wherein the beverage further comprises at least one of the following: Vitamin A, Vitamin D, Vitamin K and Vitamin B2, Vitamin E, Vitamin C, Vitamin B1, Vitamin B6, and Vitamin B12.

4. The method of claim 1, wherein the beverage comprises monatin or an UV stabilizer.

5. The method of claim 1, wherein the red coloured container is manufactured from a plastic material comprising an UV filter.

6. The method of claim 1, wherein the red coloured container is manufactured from or comprises a quantity of recycled PET or PCR equal to or greater than about 25%.

7. The method of claim 6, wherein the red coloured container is manufactured from or comprises a quantity of recycled PET greater than about 50%.

8. The method of claim 6, wherein the red coloured container is manufactured from or comprises a quantity of recycled PET or PCR greater than about 75%.

9. The method of claim 6, wherein the red coloured container is manufactured from a 100% recycled PET or PCR.

10. The method of claim 6, wherein the red coloured container is manufactured from greater than about 5% ‘secondary value’ recycled PET.

11. The method of claim 10, wherein the red coloured container is manufactured from greater than about 50% ‘secondary value’ recycled PET.

12. The method of claim 1, wherein the providing comprises forming the red coloured container.

13. The method of claim 12, wherein the forming comprises blow moulding the red container using a red coloured PET or recycled PET.

14. The method of claim 12, wherein the forming comprises: blow moulding a clear or near clear PET to form a substantially clear container; and, coating the formed clear contained with a red colourant or ink to form the red coloured container.

15. A container comprising:
an external wall defining an interior volume; and,
the internal volume adapted to receive and hold a volume of beverage, the beverage comprising carbonated water and at least one of the following ingredients: High Fructose Corn Syrup (HFCS), Stevia, Aspartame, Sucralose or any other non-nutritive sweetener;
wherein, the external wall is formed from a substantially red colour having light transmission properties between about 630 and 700 nm in wavelength and is configured to filter an UV/vis light so as to reduce light degradation of the ingredients present in the beverage.

16. A container suitable for hot-fill, the container comprising:
an external wall defining an interior volume;
a movable sidewall or moveable base portion configured to reduce vacuum pressure within the container following a cooling of heater liquid contents filled into the container; and,
the internal volume adapted to receive and hold a volume of beverage, the beverage comprising water and at least one of the following ingredients: High Fructose Corn Syrup (HFCS), Stevia, Aspartame, Sucralose or any other non-nutritive sweetener, or one of Vitamin A, Vitamin D, Vitamin K and Vitamin B2, Vitamin E, Vitamin C, Vitamin B1, Vitamin B6, and Vitamin B12;
wherein, the external wall is formed from a polymer including at least 25% PCR and containing a colour having light transmission properties above at least 630 and 700 nm in wavelength and is configured to filter an UV/visible light so as to reduce light degradation of the ingredients present in the beverage.
